(19) United States
(12) Patent Application Publication
(10) Pub. No.: US 2004/0034571 A1
(43) Pub. Date: Feb. 19, 2004

(54) Network-based ordering system and method

(76) Inventors: Nicholas John Wood, Auckland (NZ); Dave Raj Fermah, Auckland (NZ)

Correspondence Address: FINNEGAN, HENDERSON, FARABOW, GARRETT & DUNNER, LLP, 1300 I STREET, NW, WASHINGTON, DC, 20005, US

(21) Appl. No.: 10/398,806

(22) PCT Filed: Oct. 10, 2001
(86) PCT No.: PCT/NZ01/00220

(30) Foreign Application Priority Data
Oct. 10, 2000 (NZ) 507421
Dec. 7, 2000 (NZ) 508697

(51) Int. Cl. G06F 17/60

(52) U.S. Cl. 705/26

(57) ABSTRACT

The invention provides a network-based ordering system comprising one or more client devices connected to a server through a network, each client device operated by a user; one or more merchant devices connected to the server through a network, each merchant device associated with one or more merchants; a memory in which is stored a merchant product database, the database including a plurality of product data items representing products available from each merchant; a display configured to display to a user information identifying one or more product data items in the memory; a request processor configured to receive a user order from a user for one or more product data items; a dispatcher configured to receive the user order from the request processor, to transmit the user order to a delivery agent for delivery of the ordered goods to the user; and an inventory manager configured to receive a user order from the dispatcher and to update the merchant product database. The invention further provides a network-based ordering system for the provision of services and also related methods.

### FIELD OF INVENTION

The invention relates to a network-based ordering system particularly but not solely designed for the purchase of consumer goods and services over the internet.

### BACKGROUND TO INVENTION

Research available indicates that over 60% of current users of the internet and the world-wide web are searching for information. There have been several attempts in the past to tap into this online market for retail sales. Many systems attempt to reproduce a physical store online, or reproduce catalogues online. These systems have had very mixed results.

It would be particularly advantageous to offer an online consumer a method of ordering products having advantages that are not available at physical store locations. Such a system would ideally offer speed of delivery, convenience and additional information to a consumer.

### SUMMARY OF INVENTION

In one preferred form the invention comprises a network based ordering system comprising one or more client devices connected to a server through a network, each client device operated by a user; one or more merchant devices connected to the server through a network, each merchant device associated with one or more merchants; a memory in which is stored a merchant product database, the database including a plurality of product data items representing products available from two or more merchants; a display configured to display to a user information identifying one or more product data items from a plurality of merchants in the memory; a request processor configured to receive a user order from a user for one or more products; a dispatcher configured to receive the user order from the request processor, to transmit the user order to a delivery agent for delivery of the ordered products to the user; and an inventory manager configured to receive a user order from the dispatcher and to update the merchant product database.

In another preferred form the invention comprises a method of network-based ordering in which one or more client devices are connected to a server through a network, each client device operated by a user, and one or more merchant devices are connected to the server through a network, each merchant device associated with one or more merchants, the method comprising the steps of maintaining in a memory a merchant product database, the database including a plurality of product data items representing products available from two or more merchants; displaying to a user information identifying one or more product data items from a plurality of merchants in the memory; receiving a user order from a user for one or more products; transmitting the user order to a delivery agent for delivery of the ordered products to the user; and updating the merchant product database.

### BRIEF DESCRIPTION OF THE FIGURES

Preferred forms of the network-based ordering system and method will now be described with reference to the accompanying Figures in which:

FIG. 1 shows a block diagram of a system in which one form of the invention may be implemented;

FIG. 2 shows one method of selecting a delivery agent to process a user order;

FIG. 3 shows another method of selecting a delivery agent to process a user order; and

FIG. 4 shows the preferred system architecture of hardware on which the present invention may be implemented.

### DETAILED DESCRIPTION OF PREFERRED FORMS

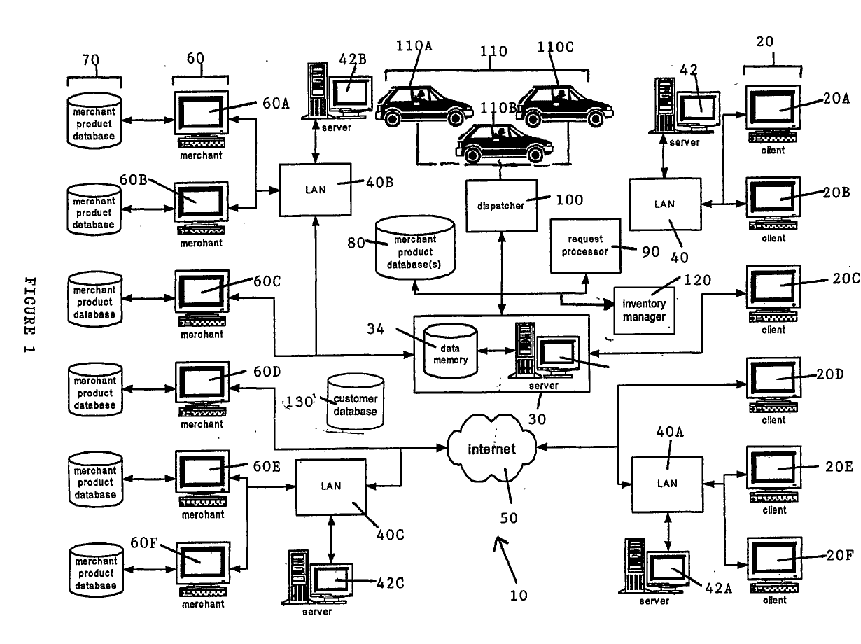

FIG. 1 illustrates a block diagram of the preferred system 10 in which one form of the present invention may be implemented. The system includes one or more client devices 20, for example 20A, 20B, 20C, 20D, 20E and 20F, which each may comprise a personal computer, workstation, WAP-enabled mobile phone or interactive TV set-top device.

Each client 20 is interfaced to a server component 30 which in turn comprises a server 32 and data memory 34 as shown in FIG. 1. Each client 20 could be connected directly to the server 30, could be connected through a local area network or LAN, could be connected through a cellular phone network, or could be connected through the Internet. In each case, the connections could be implemented as wired or wireless links between computers.

Clients 20A and 20B, for example, are connected to a network 40, such as a local area network or LAN. The network 40 could be connected to a suitable network server 42 and communicate with the server 30 as shown. Client 20C is shown connected directly to the server component 30. Clients 20D, 20E and 20F are shown connected to the server component 30 through the Internet 50. Client 20D is shown as connected to the Internet 50 with a dial-up connection and clients 20E and 20F are shown connected to a network 40A such as a local area network or LAN with the network 40A connected to a suitable network server 42A. A client could be connected to the server component 30 through a cellular phone network and appropriate gateway, or could be connected to the server component through a modem and an interactive TV gateway.

The system 10 further comprises one or more merchant devices 60, for example 60A, 60B, 60C, 60D, 60E and 60F, which each may comprise a personal computer, workstation, or fax machine. Each merchant 60 is interfaced to the server component 30 as shown in FIG. 1. Each merchant 60 could be connected directly to the server component 30, could be connected through a local area network or LAN, or could be connected through the Internet or could be connected to a public phone network.

Merchants 60A and 60B, for example, are connected to a network 40B such as a local area network or LAN. The network 40B could be connected to a suitable network server 42B and communicate with the server component 30 as shown. Merchants 60D, 60E and 60F are shown connected to the server component 30 through the Internet 50. Connections could be implemented either with a dial-up connection, as is the case with merchant 60D or through a network 40C and network server 42C. Alternatively, a merchant could be connected to a public phone network with a fax machine as the merchant device.

The system 10 could follow a client/server computing model in which application processing is divided between clients (for example computer-based clients 20 and merchants 60) and server (server component 30). The system could alternatively follow a host-based processing model performed on a single computer system (server component 30) with attached dumb terminals (clients 20 and merchants 60). Alternative variations could include master slave processing or peer-to-peer processing. It is envisaged that the system 10 could embody application service provision techniques in which server component 30 downloads and executes applications on behalf of associated client nodes. Data used in the system 10 could be maintained on a client device 20, a merchant device 60 and/or server component 30.

It is envisaged that each client device will be operated by a user and each merchant device be associated with one or more merchants. A merchant device 60 could be installed and operating at a merchant premises. The merchants display products or services to users. The system receives orders from users for one or more product data items and arranges for these product data items to be transferred from the merchant to the user.

It is envisaged that the user may place orders for products through a website or portal maintained on the server component 30. It is envisaged that different interfaces for different types of user devices be provided. For example, it is envisaged that the user place orders by telephone or fax through a call centre or processing centre which in turn could be interfaced to the server component 30. Similarly, each merchant could be connected to the system through an intermediary for example a call centre or processing centre. Such a call centre or processing centre could embody interactive voice response (IVR) or any other suitable voice enabled e-commerce solution. A customer could also order from a TV set-top box via an infrared keyboard or remote cursor using proprietary architecture and/or operating systems used for digital interactive TV.

In one preferred form of the invention, a user operating a client 20 connects to the server component 30. The server 30 preferably displays a portal to user. The preferred portal is arranged to enable a user to log on using a name and password and the server component 30 is arranged to store user details about a user, for example, residential address and postal or delivery address of the user. The portal could also offer browsing screens for non-registered members to peruse before registering.

The portal preferably displays to a user information identifying one or more products or services offered by a plurality of merchants. These products and services are typically consumer products and services, for example video rental and return, fast food, convenience store items for example milk, bread, beverages and newspapers, pharmacy supplies, alcohol, books, magazines and stationery, groceries, sports goods, telephones and mobile telephones. Typical services could include housekeeping or garden maintenance, car rental or dry-cleaning.

A product available from a merchant could include one or more gaming products. These gaming products are typically gaming tickets and other items providing the holder with a chance to win in a prize draw. Alternatively, the portal could enable a user to select one or more characters or numbers and to submit a specified entry on-line.

Where the product is a gaming product, the user could purchase such a product with a chance of winning a prize. Alternatively, it is envisaged that the user place orders for such a gaming product by telephone or fax through a cell centre or processing centre which in turn could be interfaced to the server component 30.

As shown in FIG. 1, the system 10 may further comprise one or more merchant product databases 70. Each merchant product database has stored in it a series of product data items representing products available from each merchant. Each database has stored in it at least information identifying a product for example a product identifier, the availability and quantity available of that product, and the price. The database may further comprise images and further information about each product.

Each merchant could have its own merchant product database or alternatively two or more merchants could share a common merchant product database. The merchant product database(s) 70 shown in FIG. 1 could also function or at least be interfaced to a merchant's own stock control and inventory system.

Product data items representing products are transferred from the merchant product databases 70 to the server component 30 ready for display to a user. A display is arranged to display to a user information identifying one or more of these product data items from a plurality of merchants.

It is envisaged that the server component 30 could be connected to a further merchant product database or series of merchant product databases indicated generally at 80. The database(s) 80 is/are arranged as mirror database(s) to the one or more merchant product databases 70. The merchant product database(s) 80 include a plurality of product data items representing products available from two or more merchants. One advantage of this mirror arrangement is to provide the system 10 with greater robustness in the event that a communication link between a merchant product database 70 and a merchant 60, between a merchant 60 and the server component 30, or between the merchant product database(s) 80 and the server component 30 is unexpectedly terminated.

It will be appreciated that the mirror database arrangement is best implemented in a distributed processing environment for example client server or peer-to-peer. Where a host processing model is followed, the system 10 could include a single database 80 maintained on server component 30 accessed by dumb clients (clients 20 and merchants 60).

The system further comprises a request processor 90 which is arranged to receive a user order from a user for one or more product data items. The request processor will typically present to a user an order form displaying the products on offer. The order form, for example, may enable a user to log on providing name and password. The order form could enable a user to specify a geographical area from which the products or services are to be ordered. It is also envisaged that where a user does not specify a desired geographic location, the request processor assigns a default geographic location to the user based on address data stored about the user or entered by a user.

Where the product includes a gaming product, the request processor could present to a user a gaming product entry form to be completed and submitted by the user. The gaming product entry is preferably made over the Internet or other network or combination of networks.

The request processor could also be arranged to obtain payment from a user, for example by a user supplying credit card data, by billing to a personal or company account or by finds transfer. It is envisaged that suitable security software be implemented to process the data relating to online financial transactions such as electronic signature components. In a further preferred form, a user could alternatively make payment to the delivery agent who delivers the products to the user by mobile EFTPOS, integrated circuit or smart cards, or other suitable methods of funds transfer.

It is also envisaged that the request processor 90 could include a virtual shopping basket. During an interaction with the server component 30, a user selects one or more product items to place in the shopping basket. During the interaction, a user may either add product items to a shopping basket or may remove product items. At the end of an interaction, a user can “check out” the basket.

In one form, it is envisaged that the shopping basket be displayed on a client device with associated delivery times available on-line displayed also. The customer could view a percentage value indicating how full the delivery time slots are, and how many other client devices are on-line. It is also anticipated that a user on a client device may check delivery status, and whether goods have been uplifted yet from a delivery agent, for example. The user could also specify multiple delivery addresses and choose the address most desirable for the user, with an error presented to a user if an address is chosen to which it cannot be delivered from certain merchants. The shopping cart could check individual merchant open/close times for the delivery time requested and could also check when multiple merchant orders have been placed for individual store open/close times, for example checking a store's food preparation times, open/close times, driver availability times and the like, before offering a delivery time slot to a customer. It is also envisaged that the customer could order from two or more merchants and request delivery at the same time with the one payment.

In one preferred form of the invention, each merchant is associated with a geographic location. The merchant product database could further comprise geographic data representing the geographic location of each merchant. Alternatively, the merchant product databases could further comprises groups of merchants ordered by geographic location. In this way, the request processor 90 can display to a user product data items from merchants where those merchants are either located or trade within a defined geographic area. One advantage of this arrangement is that a user may order several different products and each of those products could be provided by a different merchant. If a user is encouraged to select products from a defined geographic area, for example, the user's neighbourhood, the delay from the time the user orders the product or products to the time the products are delivered can be reduced.

The request processor 90 is arranged to receive a user order and to query the merchant product database 70 or merchant product database(s) 80 to ensure that that product is in stock and to determine the most appropriate merchant to supply that product. The request processor 90 then passes the user order to a dispatcher 100.

The merchant could transmit data to the server component 30 at particular times. For example, where a merchant restaurant is busy, the merchant could specify that it will not accept orders for a specified time period, or that it is not accepting orders until further notice. The merchant could also specify an anticipated delay for completing user orders.

In one preferred form the merchant may receive orders for products from users by telephone or fax in a conventional manner in addition to or instead of from server component 30. On receiving such a conventional order, the merchant could enter the order manually and transmit the order to the server component 30, for subsequent processing by the system 10 by telephone, fax, or electronically. The system could also prepare a “pop-up” order for a merchant to print out and process in a conventional manner.

The preferred dispatcher 100 transmits a message to a suitable delivery agent, indicated generally at 110, for example 110A, 110B or 110C. It is also envisaged that the dispatcher could transmit a product in the form of a gaming product to the user over the network. In a further form, the dispatcher 100 could further include a pay-out component configured to transfer notification of a win in a gaming product entry over the network to a user. Such notification could include an electronic document to be printed out at a client workstation and delivered or otherwise transferred to the merchant 60 for pay-out by the merchant. As a further alternative, the request processor 90 could include a pay-out component which is configured to transfer money electronically over the network to the client, where the money results from a win in a gaming product entry.

The preferred delivery agent 110 is a courier, postal service worker, or other operator having a vehicle equipped with a mobile data terminal or MDT. The delivery agent 110 is also preferably equipped with a global positioning system or GPS. The dispatcher 100 preferably includes a radio transmitter and sends a message to a delivery agent 110 over a radio network. The message alerts the particular delivery agent 110 to pick up a particular product for a particular merchant and to deliver the product to a particular user.

It is envisaged that other methods of communicating between dispatcher 100 and delivery agents 110 could be used. Examples include text messaging over mobile or radio networks, paging apparatus, and other wireless application protocol (WAP) devices. Each delivery agent could be provided with an MDT or radio telephone or WAP or equivalent mobile communication set to receive orders and confirm acceptance of an order, delivery of an order and/or payment.

The dispatcher 100 preferably includes software to select the most appropriate agent for a particular delivery. The delivery agent 110, for example, could route the order to the closest delivery agent or alternatively could route the order to the delivery agent with the least number of outstanding jobs. Preferred methods of selecting the most appropriate delivery agent are described below.

Once a delivery agent 110 receives an order from the dispatcher 100, the delivery agent 110 travels to the merchant site specified in the dispatch request to pick up the specified product or products. The product or products are transferred from the merchant 60 to the delivery agent 110.

The merchant product database 70 for the appropriate merchant 60 is updated to reflect that a product has been uplifted from that merchant and is no longer available for sale. This change is also preferably sent to the server component 30 to update the mirror site merchant product database(s) 80. An inventory manager 120 could be implemented as a software program configured to receive a user order from the dispatcher and to update the merchant product database 70 and/or mirror site 80 to reflect the fact that a product has been uplifted and no longer available to a client.

The delivery agent 110 could pick up further products from further merchants 60, particularly where a user has ordered two or more products from different merchants. The delivery agent 110 then proceeds to the premises of the user specified in the dispatch request.

Preferably the delivery agent 110 is fitted with a GPS unit, and the geographic location of a delivery agent is transmitted at regular intervals to the dispatcher 100. The geographic location of the delivery agent is then displayed to a user, enabling the user to track progress of a particular order. It is also envisaged that when a delivery agent 110 has uplifted a product for a merchant 60, the product uplifted is recorded in the mobile data terminal or MDT of the delivery agent. This data could also be transferred to the dispatcher 100 and displayed to a user to provide a user with further information regarding particular orders currently logged with a delivery agent.

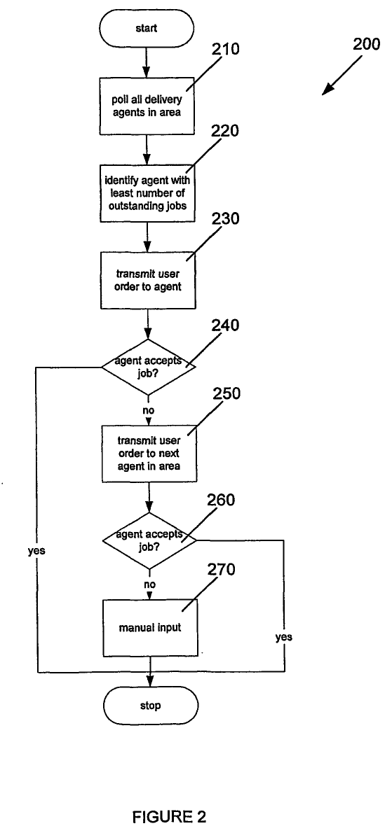

As described above, the dispatcher 100 selects the most appropriate delivery agent to process a user order. FIG. 2 illustrates one preferred method of selection indicated generally at 200. As shown at 210, all delivery agents are polled to identify all drivers which are currently “logged on” or operating in a particular geographic area. One or more delivery agents could be assigned to a geographic area or store and this data could be stored in a table and accessed by the dispatcher.

As described above, the mobile data terminal or MDT of each delivery agent has stored in it details of customer orders being processed by that delivery agent. As shown at 220, the agent with the least number of outstanding jobs is identified and as shown at 230, the user order is transmitted to that agent. In this way user orders are transmitted to a delivery agent based on user orders already transmitted to the delivery agent.

Where two delivery agents have an identical number of outstanding jobs, for example jobs which are accepted but not completed, the dispatcher 100 could assign user orders on a rotational basis. For example, the first time equal numbers occur, a user order could be dispatched to the first delivery agent and the second time an equal number occurs, the user order could be dispatched to the second driver.

If there are no delivery agents logged on to the dispatched order, a user order is neither assigned nor dispatched. The orders remain in the dispatcher 100 unassigned and undispatched and an alarm is generated to signal that manual intervention is required.

If a delivery agent accepts a job as shown at 240, the delivery agent selection process is completed. On the other hand, if the agent does not accept the job, the user order is transmitted to the next agent in the area as indicated at 250. If that agent accepts the user order as indicated at 260, the delivery agent selection process terminates. On the other hand, if the second delivery agent does not accept the job, an alarm is generated signalling that manual intervention or manual input is required as indicated at 270.

It is envisaged that each delivery agent be able to transmit data to the dispatcher in addition to geographic position and order status. The delivery agent could, for example, signal to the dispatcher that the delivery agent does not wish to accept any further orders for a predetermined time, in circumstances where the delivery agent requires a break or has exceeded a comfortable level or orders in progress. It is envisaged that the delivery agent could specify a delay in order delivery availability time so that a customer cannot request a 30 minute delivery of a product or service if the driver is too busy to provide the service in this time frame.

Similarly, a merchant could specify a delay in the same way as a delivery agent. For example, where a restaurant is too busy to deliver take-out dinners for a specified time, the non-availability of products or services from this restaurant could be recorded in the merchant product database(s).

It is envisaged that the dispatcher could allocate a maximum number of jobs per set period. Once this maximum has been reached, a particular delivery agent is no longer available at that time. It is envisaged that the number of delivery agents in a particular geographic area could be pre-specified for a particular time interval.

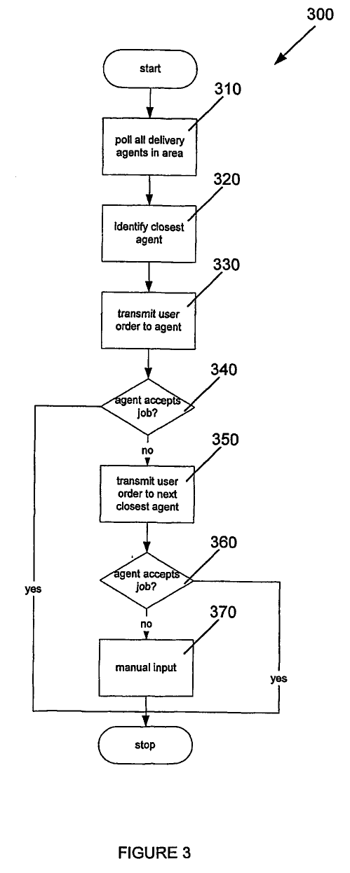

FIG. 3 illustrates another preferred method of selection indicated generally at 300. As shown at 310, all delivery agents are polled to identify all drivers which are currently “logged on” in a particular geographic area.

As shown at 320, the agent who is closest is identified and as shown at 330, the user order is transmitted to that agent. The proximity of a delivery agent could be calculated as the distance from the user's premises or delivery address to the delivery agent. Alternatively the proximity could be calculated as the distance from the merchant specified in the order to the agent. Where there is more than one merchant specified in the order, the proximity could be calculated as a function of the locations of each merchant and the agent.

If there are no delivery agents logged on to the dispatched order, a user order is neither assigned nor dispatched. The orders remain in the dispatcher 100 unassigned and undispatched and an alarm is generated to signal that manual intervention is required.

If a delivery agent accepts a job as shown at 340, the delivery agent selection process is completed. On the other hand, if the agent does not accept the job, the user order is transmitted to the next closest agent in the area as indicated at 350. If that agent accepts the user order as indicated at 360, the delivery agent selection process terminates. On the other hand, if the second delivery agent does not accept the job, an alarm is generated signalling that manual intervention or manual input is required as indicated at 370.

Referring to FIG. 1, the system 10 could further comprise a customer database 130. A typical customer database could include a user identifier in addition to demographic data about each user or customer, for example geographic location, professional status, family size, age, gender, marital status, ethnicity, education and vocation. Where the user is a commercial business, the customer database may store data relating to the number of employees and the industry code of the business.

As users on clients 20 purchase products and services from merchants 60, the system 10 could compile data relating to each transaction, for example the monetary value of the transaction, a product/service identifier, and/or the date and time of the transaction. In this way each merchant could obtain data about its customers, for example demographic data and purchasing habits, to assist the merchant in marketing its products and services.

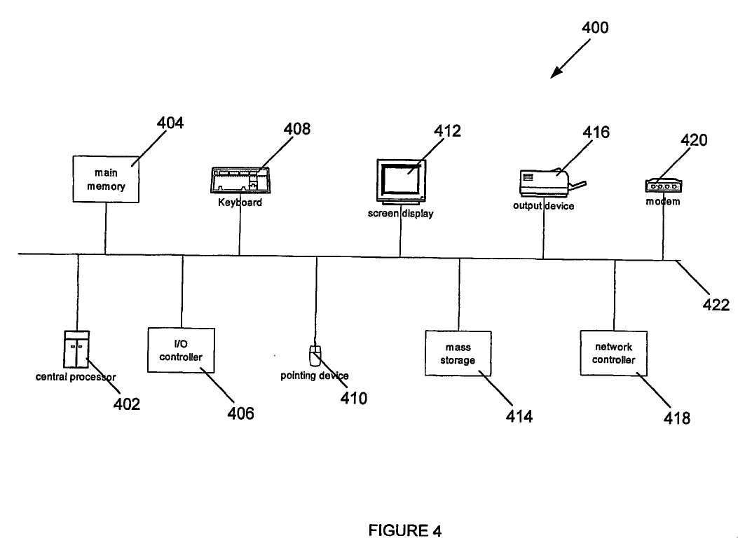

FIG. 4 shows the preferred system architecture of a client 20, server component 30 and merchant 60. The computer system 400 typically comprises a central processor 402, a main memory 404 for example RAM and an input/output controller 406. The computer system 400 also comprises peripherals such as a keyboard 408, a pointing device 410 for example a mouse, trackball or touch pad, a display or screen device 412, a mass storage memory 414, for example a hard disk, floppy disk or optical disc, and an output device 416, for example a printer. The system 400 could also include a network interface card or controller 418 and/or a modem 420. The system 400 could further include wireless data transmission apparatus. The individual components of the system 100 could communicate through a system bus 422.

It will be appreciated that the system architecture will differ depending on the particular device, for example a personal computer, workstation, WAP-enabled mobile phone, interactive set-top device, or fax machine. In each case, the client device is provided with, or interfaced to, a display configured to display to a user information identifying one or more product data items from the merchant product database.

The network-based system described above could optionally include a self-diagnostics and monitoring module configured to provide continuous monitoring of system hardware and software components where applicable. This could include merchant devices and software installed on these merchant devices, servers, databases, the dispatcher, request processor and so on. The monitoring module could automatically disable or enable appropriate modules and/or system functions, notify corresponding service personnel and users through different notification channels including but not limited to web server messages (MOTD), email, paging, SMS messaging, WAP notification and computer/synth voice phone calls.

The system could also optionally include an interface to the request processor configured to provide routing of incoming calls to either a merchant or to a call centre operator. The interface would also provide an ability to place orders into the system on the behalf of a user.

The system could also include a merchant interface editing module configured to enable merchants to change a visual presentation or look and feel of a merchant's products or services and user-oriented facilities for different types of user devices, for example a computer-implemented browser, WAP, fax product list and so on. This editing module could enable merchants to modify a page layout, colours, fonts, images, enable or disable different user-oriented facilities such as a search facility, select types of product or service listings, add/remove the most popular products/services, or most popular merchants including the top 20 products/services or merchants, special offers sections and so on.

The invention provides a convenient method for consumers to purchase goods and services from local merchants using an online network or interactive television service.

The foregoing describes the invention including preferred forms thereof. Alterations and modifications as will be obvious to those skilled in the art are intended to be incorporated within the scope hereof, as defined by the accompanying claims.

1. A network based ordering system comprising:
one or more client devices connected to a server through a network, each client device operated by a user;
one or more merchant devices connected to the server through a network, each merchant device associated with one or more merchants;
a memory in which is stored a merchant product database, the database including a plurality of product data items representing products available from two or more merchants;
a display configured to display to a user information identifying one or more product data items from a plurality of merchants in the memory;
a request processor configured to receive a user order from a user for one or more products;
a dispatcher configured to receive the user order from the request processor, to transmit the user order to a delivery agent for delivery of the ordered products to the user; and
an inventory manager configured to receive a user order from the dispatcher and to update the merchant product database.

2. A network based ordering system as claimed in claim 1 wherein each merchant is associated with a geographic location, the merchant product database further including geographic data representing the geographic location of each merchant.

3. A network based ordering system as claimed in claim 2 wherein the merchant product database further includes one or more groups of merchants ordered by geographic location.

4. A network based ordering system as claimed in claim 3 wherein the display is configured to display to a user two or more product data items from two or more merchants in which the merchants are located within a defined geographic area.

5. A network based ordering system as claimed in any one of the preceding claims wherein one or more of the delivery agents is arranged to transmit the geographic position of the delivery agent to the dispatcher.

6. A network based ordering system as claimed in claim 5 wherein the dispatcher is configured to transmit a user order to a delivery agent based on the geographic position of the delivery agent.

7. A network based ordering system as claimed in any one of the preceding claims wherein one or more of the delivery agents is arranged to transmit to the dispatcher data representing user orders already transmitted to the delivery agent.

8. A network based ordering system as claimed in claim 7 wherein the dispatcher is configured to transmit a user order to a delivery agent based on user orders already transmitted to the delivery agent.

9. A method of network-based ordering in which one or more client devices are connected to a server through a network, each client device operated by a user, and one or more merchant devices are connected to the server through a network, each merchant device associated with one or more merchants, the method comprising the steps of:
maintaining in a memory a merchant product database, the database including a plurality of product data items representing products available from two or more merchants;
displaying to a user information identifying one or more product data items from a plurality of merchants in the memory;
receiving a user order from a user for one or more products;
transmitting the user order to a delivery agent for delivery of the ordered products to the user; and
updating the merchant product database.

10. A method as claimed in claim 9 wherein each merchant is associated with a geographic location, the merchant product database further including geographic data representing the geographic location of each merchant.

11. A method as claimed in claim 10 wherein the merchant product database further includes one or more groups of merchants ordered by geographic location.

12. A method as claimed in claim 11 further comprising the step of displaying to a user two or more product data items from two or more merchants in which the merchants are located within a defined geographic area.

13. A method as claimed in any one of claims 9 to 12 further comprising the step of one or more of the delivery agents transmitting the geographic position of the delivery agent over the network.

14. A method as claimed in claim 13 further comprising the step of transmitting a user order to a delivery agent based on the geographic position of the delivery agent.

15. A method as claimed in any one of claims 9 to 14 further comprising the step of one or more of the delivery agents transmitting over the network data representing user orders already transmitted to the delivery agent.

16. A method as claimed in claim 15 further comprising the step of transmitting a user order to a delivery agent based on user orders already transmitted to the delivery agent.
